(19) United States
(12) Patent Application Publication
(10) Pub. No.: US 2024/0098434 A1
(43) Pub. Date: Mar. 21, 2024

(54) METHOD AND DEVICE FOR AUDIO STEERING USING GESTURE RECOGNITION

(71) Applicant: InterDigital CE Patent Holdings, SAS, Paris (FR)

(72) Inventors: Hassane Guermoud, Thorigne Fouillard (FR); Michel Kerdranvat, Chantepie (FR); Alexey Ozerov, Rennes (FR)

(21) Appl. No.: 18/038,544

(22) PCT Filed: Nov. 29, 2021
(86) PCT No.: PCT/EP2021/083286

§ 371 Date: May 24, 2023

(30) Foreign Application Priority Data
Dec. 3, 2020 (EP) 20306486.0

(51) Int. Cl. H04S 1/00; G06F 3/01

(52) U.S. Cl. CPC H04S 1/002; G06F 3/012; G06F 3/017

(57) ABSTRACT

A method and device for audio steering from a loudspeaker line array of a display device toward a user direction is disclosed. Data corresponding to a viewer gesture is obtained from at least one sensor of a display device. A distance and an angle between the viewer and a plurality of loudspeakers coupled to the display is determined based on the obtained data. Phase shifting is applied to an audio signal powering the plurality of loudspeakers based on the determined distance and angle to audio steer toward the user direction.

### TECHNICAL FIELD

The present disclosure generally relates to audio steering. At least one embodiment relates to audio steering from a loudspeaker line array of a display device toward a user direction.

### BACKGROUND

When several people are watching video content on a display device, sometimes some of them may have less interest or be distracted. Referring to FIG. 1, there is illustrated an example group setting in which many people are shown in an area where a display device 50 is displaying video content. In this view, some people may be distracted by a phone call 100, others may speak to each other 110, some may browse a tablet 120 and/or some 130 may actually have an interest in watching the displayed video content. Such a situation can make it uncomfortable for those person(s) who want to watch the video content. Typically, someone will turn up the volume on the display device and the others talking on the phone or to each other will speak louder exacerbating the problem.

One way to overcome this situation has been to steer the audio towards the person(s) who are interested in watching the video content. For example, a beamforming method may be used for audio signal processing of a display device equipped with a loudspeaker array (e.g., a soundbar). Referring to FIG. 2, by controlling the rendering of an array of loudspeakers 210, using a beamforming technique, such as, for example, Delay and Sum, constructive interference 220 of audio waveforms can be generated towards a specific location/person 130 in a room and destructive interference (not shown) of audio waveforms elsewhere in the room. For such a situation, the audio waveform is guided in a direction 230 towards the person 130 who is interested in watching the video content.

Unfortunately, audio beamforming techniques typically rely on a calibration step, in which an array of control points, for example, an array of microphones are used to determine the angle and the distance towards where the audio beam is to be steered. Such a determination is made by measuring the delay between the sound emitted by the loudspeakers and received by the microphones. This is a time-consuming step that will also depend on the location(s) of person(s) in the room, that may not be known in advance. Moreover, a calibration step needs to be performed in advance, which may not be compatible with an on-demand situation. Additionally, consumer electronics devices need to be user friendly without the need for a calibration step. The embodiments herein have been devised with the foregoing in mind.

### SUMMARY

The disclosure is directed to a method using viewer gestures to initiate audio steering from a loudspeaker line array of a display device toward a user direction. The method may take into account implementation on display devices, such as, for example, digital televisions, tablets, and mobile phones.

According to a first aspect of the disclosure, there is provided a device, comprising a display device including an image sensor and at least one processor. The at least one processor is configured to: obtain from the image sensor, data corresponding to a viewer gesture; determine a distance and an angle between the viewer and a plurality of loudspeakers coupled to the display based on the obtained data; and apply phase shifting to an audio signal powering the plurality of loudspeakers, based on the determined distance and angle.

According to a second aspect of the disclosure, there is provided a method, comprising: obtaining from at least one image sensor of a display device, data corresponding to a viewer gesture; determining a distance and an angle between the viewer and a plurality of loudspeakers coupled to the display based on the obtained data; and applying phase shifting to an audio signal powering the plurality of loudspeakers based on the determined distance and angle.

The general principle of the proposed solution relates to using viewer gestures to initiate audio steering from a loudspeaker line array of a display device toward a user direction. The audio steering is performed on-the-fly based on a touchless interaction with the display device without relying on a calibration step or use of a remote-control device.

Some processes implemented by elements of the disclosure may be computer implemented. Accordingly, such elements may take the form of an entirely hardware embodiment, an entirely software embodiment (including firmware, resident software, microcode, etc.) or an embodiment combining software and hardware aspects that may all generally be referred to herein as “circuit”, “module” or “system”. Furthermore, such elements may take the form of a computer program product embodied in any tangible medium of expression having computer useable program code embodied in the medium.

Since elements of the disclosure can be implemented in software. The present disclosure can be embodied as computer readable code for provision to a programmable apparatus on any suitable carrier medium. A tangible, non-transitory, carrier medium may comprise a storage medium such as a floppy disk, a CD-ROM, a hard disk drive, a magnetic tape device or a solid-state memory device and the like. A transient carrier medium may include a signal such as an electrical signal, an optical signal, an acoustic signal, a magnetic signal or an electromagnetic signal, e.g., a microwave or RF signal.

### BRIEF DESCRIPTION OF THE DRAWINGS

Other features and advantages of embodiments shall appear from the following description, given by way of indicative and non-exhaustive examples and from the appended drawings, of which:

FIG. 1 illustrates a prior art example group setting in which several people are shown in an area where a television is displaying video content;

FIG. 2 illustrates an example prior art audio beamforming technique;

FIG. 3 depicts an apparatus for audio steering from a display device toward a user direction according to an example embodiment of the disclosure;

FIG. 4 is a flowchart of a particular embodiment of a proposed method for audio steering from a loudspeaker line array of a display device toward a user direction according to an example embodiment of the disclosure;

FIG. 5 depicts an illustration of a user gesture which may be used to implement the example embodiment of the disclosure;

FIG. 6 depicts an illustration of another user gesture which may be used to implement the example embodiment of the disclosure;

FIG. 7 depicts an illustration of a user gesture and obtaining data corresponding to the user gesture;

FIG. 8 depicts an illustration of a top view of the user gesture shown in FIG. 7 and obtaining data corresponding to the user gesture;

FIG. 9 depicts an illustration of a side view of a viewer gesture in a first position;

FIG. 10 depicts an illustration of another side view of a viewer gesture in a second position; and

FIG. 11 depicts an illustration of a loudspeaker (audio) array which may be used to implement the example embodiment of the disclosure.

### DETAILED DESCRIPTION

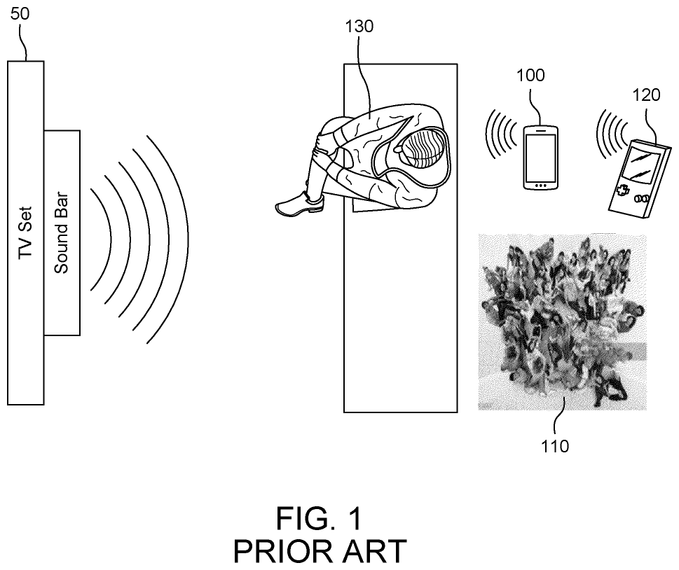

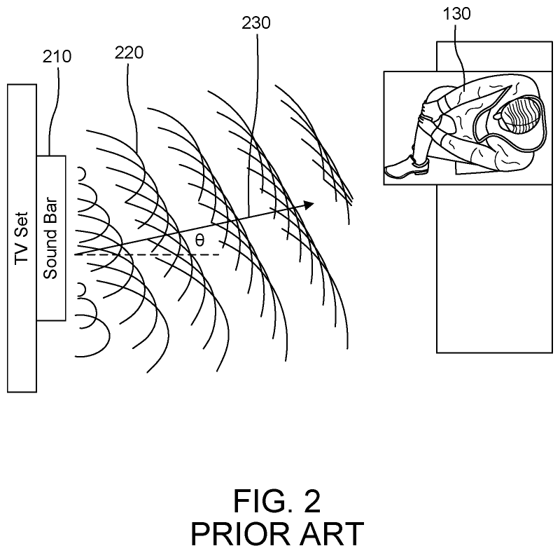

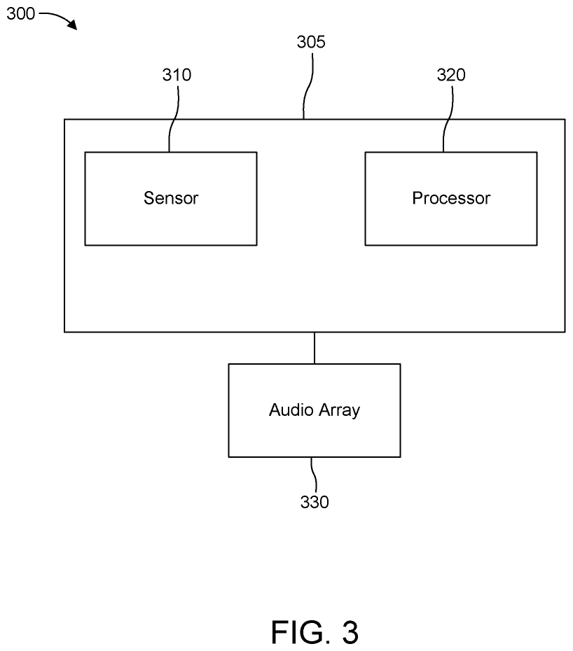

FIG. 3 illustrates an example apparatus for audio steering from a display device towards a user direction according to an embodiment of the disclosure. FIG. 1 shows a block diagram of an example apparatus 300 in which various aspects of the example embodiments may be implemented. The apparatus may include a display device 305 and an audio array 330.

The display device 305 may be any consumer electronics device incorporating a display screen (not shown), such as, for example, a digital television. The display device 305 includes at least one processor 320 and a sensor 310. Processor 320 may include software that is configured to determine distance and angle estimation with respect to a user location. Processor 320 may also be configured to determine the phase shift applied to the audio signals powering the audio array 330. The sensor 310 identifies gestures performed by a user (not shown) of the display device 305.

The processor 320 may include embedded memory (not shown), an input-output interface (not shown), and various other circuitries as known in the art. Program code may be loaded into processor 320 to perform the various processes described hereinbelow.

Alternatively, the display device 305 may also include at least one memory (e.g., a volatile memory device, a non-volatile memory device) which stores program code to be loaded into the processor 320 for subsequent execution. The display device 305 may additionally include a storage device (not shown), which may include non-volatile memory, including but not limited to EEPROM, ROM, PROM, RAM, DRAM, SRAM, flash, a magnetic disk drive, and/or an optical disk drive. The storage device may comprise an internal storage device, an attached storage device, and/or a network accessible storage device, as non-limiting examples.

The sensor 310 may be any device that can identify gestures performed by a user of the display device 305. In one example embodiment, the sensor may be, for example, a camera, and more specifically an RGB camera. The sensor 310 may be internal to the display device 305 as shown in FIG. 3. Alternatively, in an example embodiment, the sensor 310 may be external to the display device 305. For such a situation, the sensor 310 may preferably be positioned on top of the display device or adjacent thereto (not shown).

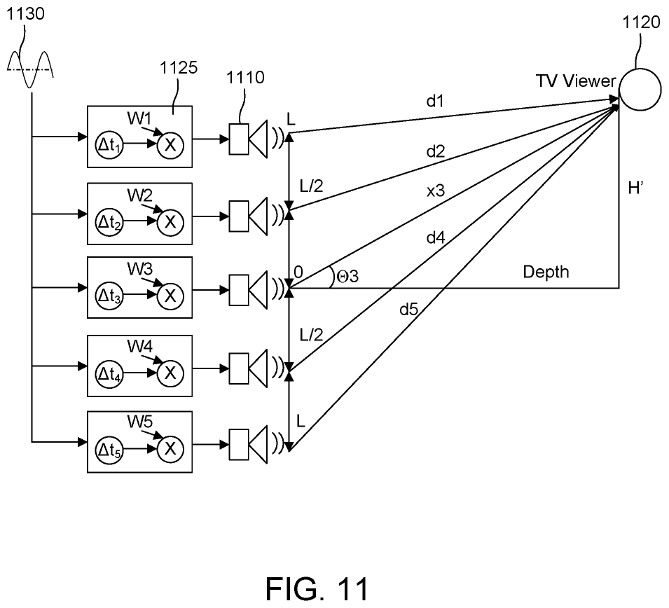

The audio array 330 is an array of loudspeakers arranged in a line (see FIG. 11 hereinafter). In one example embodiment, the audio array includes at least two loudspeakers. The audio array 330 may be external to the display device 305, as shown in FIG. 3. The audio array may be positioned in front of and below a bottom portion of the display (so as to not hinder viewability), on top of the display device 305, or adjacent to a side thereof. Alternatively, in an example embodiment the audio array may be internal to the display device 305 (not shown).

The general principle of the proposed solution relates to using viewer gestures to initiate audio steering from a loudspeaker line array of a display device toward a user direction. The audio steering is performed on-the-fly, based on a touchless interaction with the display device without relying on a calibration step or use of a remote-control device.

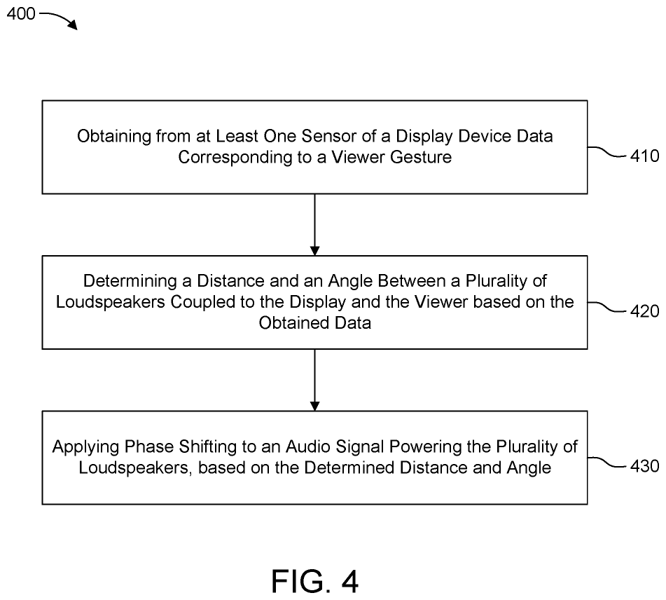

FIG. 4 is a flowchart of a particular embodiment of a proposed method 400 for audio steering from a loudspeaker line array of a display device toward a user direction according to an embodiment of the disclosure. In this particular embodiment, the method 400 includes three consecutive steps 410 to 430.

In the example implementation, the method is carried out by apparatus 300 (FIG. 3). As described in step 410, at least one sensor of a display device 305 obtains data corresponding to a viewer gesture.

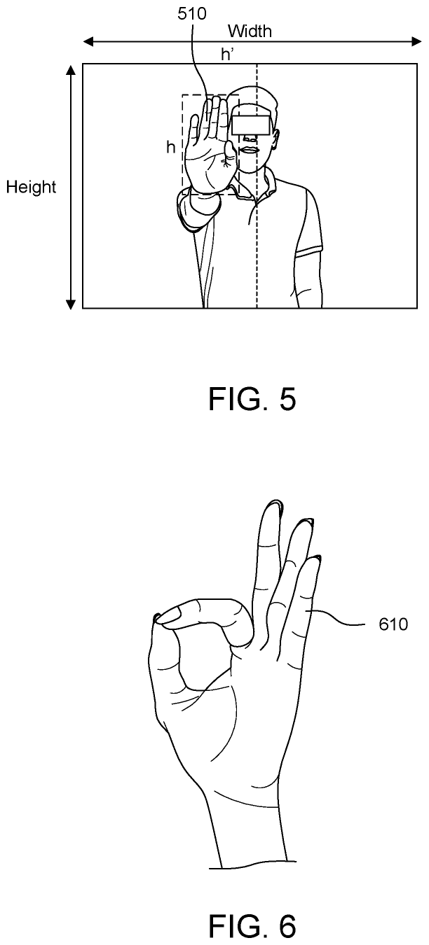

FIG. 5 shows an example illustration depicting a user gesture 510. In this example embodiment, the user gesture 510 is a hand gesture. However, the user gesture may also include, for example, facial expressions, head movement from side-to-side, head nodding, arm movements from side-to-side, etc.

Referring again to FIG. 5, the hand gesture depicted is one of a palm of the hand facing away from the user. Other hand gestures, for example, may include holding up one or more finger of a hand (not shown), holding up a thumb of a hand (not shown), finger pointing (not shown), or making a circle by contacting any finger of the hand with the thumb 610, as shown in FIG. 6.

In one example embodiment, a set of known user gestures may be available to the processor 320. For such an embodiment, when one user gesture of the set of known user gestures is detected by the sensor 310, audio steering from the display device towards a user direction is initiated.

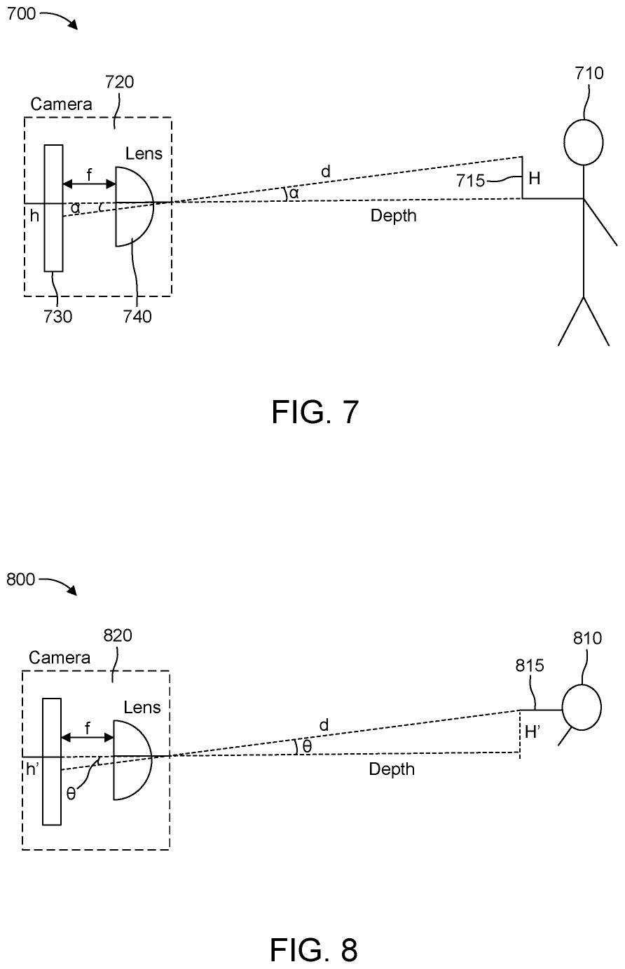

FIG. 7 depicts an illustration 700 of a user gesture and obtaining data corresponding to the user gesture. A user 710 is shown displaying a hand gesture 715. A sensor 720 detects the user 710 hand gesture 715. The sensor 720 (e.g., camera) includes an imager 730 and a lens 740. The imager 730 captures the intensity of light with regard to the hand gesture and memory devices (not shown) store the information as, for example, RGB color space.

FIG. 8 depicts an illustration 800 of a top view of the viewer gesture and obtaining data corresponding to the user gesture. A user 810 is shown displaying a hand gesture 815. A sensor 820 detects the user 810 hand gesture 815.

Referring to step 410 of FIG. 4, once a user gesture is identified based on known user gestures, data relevant to estimating the distance and the angle location of the user 710 is obtained. The estimation is performed depending on the location of the user hand that is initiating the audio steering.

Referring to FIGS. 7 and 8, in an example embodiment, there is shown how the angle and distance between the sensor 720 and the user 710 are determined as

$$d = \frac{Depth}{cos θ} with$$

$$θ = {tan}^{- 1} \frac{f}{{h}^{′}} ; Depth = \frac{f}{h} * H ; {H}^{′} = \frac{{h}^{′}}{f} * Depth$$

where d is the distance of the hand (FIGS. 7 and 8) to the focal plane of the sensor (camera), h is the hand height in pixels (FIG. 5), h′ is the distance of the hand to the half width of the image (FIG. 8), H is the hand height (size) in centimeters of an average adult person (FIG. 7), f is the sensor (camera) focal length in pixels (FIGS. 7 and 8), H′ is the horizontal length between the hand to the half width of the hand plan in the scene observed by the camera, Depth is the distance from the camera to the intersection of the hand plan in the scene.

The hand height (H) can vary depending on gender and age. In an example embodiment, a gender and age estimation based on face capture may be used to approximate this variable. For example, gender and age estimation may be estimated using—MANIMALA ET AL., “Anticipating Hand and Facial Features of Human Body using Golden Ratio”, International Journal of Graphics & Image Processing, Vol. 4, No. 1, February 2014, pp. 15-20.

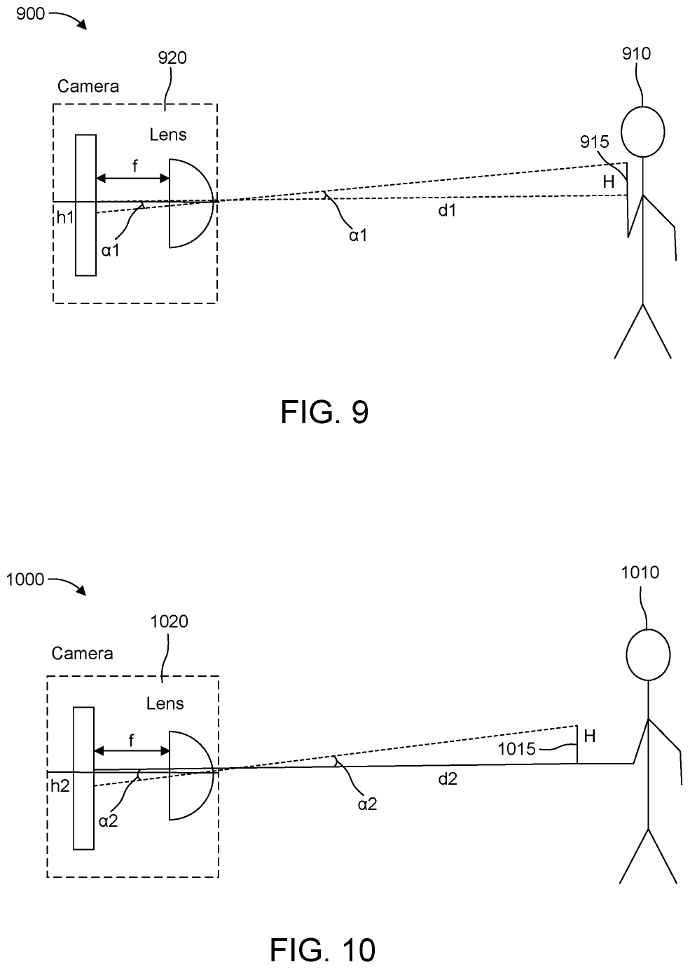

Referring to FIGS. 7 and 8, the image sensor focal length (f) is an important parameter. In an embodiment, it can be calculated as described below with respect to FIGS. 9 and 10.

FIG. 9 depicts an illustration 900 of a side view of a viewer gesture. A user 910 is shown displaying a hand gesture 915 in a first position (d₁). A sensor 920 obtains an image of the hand gesture 915 in the first position (d₁). In this example embodiment, the user presents his/her hand in a first position hand open as facing away from the user close to shoulder height.

FIG. 10 depicts an illustration 1000 of another side view of a viewer gesture. A user 1010 is shown displaying a hand gesture 1015 in a second position (d₂). A sensor 1020 obtains an image of the hand gesture 1015 in the second position (d₂). In this example embodiment, the user presents his/her hand in a second position hand open as extending the forearm away from the user at shoulder height towards the sensor direction.

Based on the images of the hand gestures for the first position (d₁) and the second position (d₂) depicted in FIGS. 9 and 10, the sensor focal length (f) is obtained from

$$f = \frac{( {d}_{1} - {d}_{2} )}{( \frac{1}{{h}_{1}} - \frac{1}{{h}_{2}} ) * H} with ( {d}_{1} - {d}_{2} ) = 1.618 * H$$

where d₁−d₂ is the length of the user forearm and has a relation with the hand height through gender and age estimation (MANIMALA ET AL., “Anticipating Hand and Facial Features of Human Body using Golden Ratio”, International Journal of Graphics & Image Processing, Vol. 4, No. 1, February 2014, pp. 15-20) (FIGS. 9 and 10), h₁ is the hand height in pixels for the first position, h₂ is the hand height in pixels for the second position, and H is the hand height in centimeters of an average adult person,

Referring to step 420 of FIG. 4, the obtained data corresponding to a viewer gesture is used to determine a distance and an angle between a viewer and a plurality of loudspeakers 330 (audio array) coupled to the display device (FIG. 3).

FIG. 11 depicts an illustration of a loudspeaker (audio) array which may be used to implement the example embodiment of the disclosure. In FIG. 11, loudspeakers 1110 are arranged in a line array configuration. Such a line array configuration may be used to direct the audio towards a desired user 1120 direction. In an example embodiment, the loudspeaker array is positioned adjacent to a bottom portion of the display device (FIG. 3).

In FIG. 11, each input of a loudspeaker 1110 is coupled to a shifting phase and gain controller 1125, which is fed with an identical audio source 1130. The distance between each of the loudspeakers of the array is preferably the same. Additionally, the directivity of the audio waves is more steerable with an increase in the number of loudspeakers.

As in FIG. 4 at step 430, based on the determined distance an angle between a plurality of loudspeakers 1110 and the user, a phase shift is applied to an audio signal powering the plurality of loudspeakers as

$$Δ {t}_{i} = \frac{( {x}_{max} - {x}_{i} )}{C}$$

where tᵢ is the phase shift to be applied to the audio signal, xᵢ is the distance between the loudspeaker at position i and the hand of the user located in the scene, xₘₐₓ=max(xᵢ) which is the longest distance between loudspeakers and the hand of user located in the scene.

$${x}_{i} = \frac{Depth}{cos θ} with {θ}_{i} = {tan}^{- 1} \frac{abs ( {H}^{′} - {l}_{i} )}{Depth} and - L \leq {l}_{i} \leq L$$

where Depth is the distance between the camera to the intersection of the hand plan in the scene, θᵢ is the angle between xᵢ and Depth, and lᵢ is the horizontal distance between the camera and the loudspeaker at position i.

In an example embodiment, the viewer gesture is used to direct phase shifting of the audio signal powering the plurality of loudspeakers away from a location for the viewer. For this embodiment, the viewer may not be interested in the displayed video content and he/she might want to browse a mobile phone or tablet. The viewer initiates the phase shifting to guide the audio signal in the direction of person(s) watching the displayed video content. The viewer gesture to initiate such audio phase shifting may be, for example, to have the arm movement to swipe towards a left direction to direct audio towards people on the left of the viewer, or have the arm movement to swipe towards a right direction to direct audio towards people on the right of the viewer.

Although the present embodiments have been described hereinabove with reference to specific embodiments, the present disclosure is not limited to the specific embodiments, and modifications will be apparent to a skilled person in the art which lie within the scope of the claim.

Many further modifications and variations will themselves to those versed in the art upon making reference to the foregoing illustrative embodiments, which are given by way of example only and which are not intended to limit the scope of the disclosure, that being determined solely by the appended claims. In particular, the different features from different embodiments may be interchanged, where appropriate.

1. A system, comprising:
a display device including an image sensor; and
at least one processor, configured to:
obtain, from the image sensor, data corresponding to a gesture of a viewer;
determine respective distances between the viewer and a plurality of loudspeakers coupled to the display device based on the obtained data; and
shifting respectively audio signals powering the plurality of loudspeakers, based on the determined respective distances.

2. The system of claim 1, wherein the image sensor is a camera.

3. The system of claim 1, wherein the viewer gesture is one of a hand gesture, a facial expression, a head movement from side-to-side, head nodding, and arm movements from side-to-side.

4. The system of claim 3, wherein the hand gesture is one of holding up one hand palm flat, holding up one of more fingers, holding up a thumb and making a circle by contacting any finger with the thumb.

5. The system of claim 1, wherein the plurality of loudspeakers is configured as a line array.

6. The system of claim 1, wherein the plurality of loudspeakers is positioned adjacent to a bottom portion of the display device.

7. The system of claim 1, wherein an input for each loudspeaker in the plurality of loudspeakers is coupled to a phase-shifting gain controller which is fed with an audio source.

8. The system of claim 1, wherein the viewer gesture is used to direct phase shifting of the audio signal powering the plurality of loudspeakers away from a location for the viewer.

9. The system of claim 1, wherein an image sensor focal length for the image sensor is obtained based on images of viewer gestures for a first position and a second position.

10. The system of claim 3, wherein a hand size of the hand gesture is obtained using gender and age estimation based on face capture.

11. A method, comprising:
obtaining, from at least one image sensor of a display device, data corresponding to a gesture of a viewer;
determining respective distances between the viewer and a plurality of loudspeakers coupled to the display device based on the obtained data; and
shifting respectively signals powering the plurality of loudspeakers based on the determined respective distances.

12. The method of claim 11, wherein the image sensor is a camera.

13. The method of claim 11, wherein the viewer gesture is one of a hand gesture, a facial expression, a head movement from side-to-side, head nodding, and arm movements from side-to-side.

14. The method claim 13, wherein the hand gesture is one of holding up one hand palm flat, holding up one of more fingers, holding up a thumb and making a circle by contacting any finger with the thumb.

15. The method of claim 11, wherein the plurality of loudspeakers is configured as a line array.

16. The method of claim 11, wherein the plurality of loudspeakers is positioned adjacent to a bottom portion of the display device.

17. The method of claim 11, wherein an input for each loudspeaker in the plurality of loudspeakers is coupled to a phase-shifting gain controller which is fed with an audio source.

18. The method of claim 11, wherein the viewer gesture is used to direct phase shifting of the audio signal powering the plurality of loudspeakers away from a location for the viewer.

19. (canceled)

20. The method of claim 13, wherein a hand size of the hand gesture is obtained using gender and age estimation based on face capture.

21. A computer program product comprising instructions which when executed cause a processor to implement the method of claim 11.
